(19) United States
(12) Patent Application Publication
(10) Pub. No.: US 2005/0077471 A1
(43) Pub. Date: Apr. 14, 2005

(54) Bulk material analyser and method of assembly

(75) Inventors: Michael Francis Edwards, Glenunga (AU); Peter Busby, Athelstone (AU); Andrew Roland Harris, Seaview Downs (AU); James Hubert Asbury, North Mackay (AU); Timothy Richard Barratt, Glenalta (AU); Nick Deans, Woodcroft (AU); Kenneth Graham Smith, Wayville (AU)

Correspondence Address: NIXON PEABODY, LLP, 401 9TH STREET, NW, SUITE 900, WASHINGTON, DC, 20004-2128, US

(73) Assignee: Scantech Intrnational Pty Ltd., Australia (AU)

(21) Appl. No.: 10/500,388

(22) PCT Filed: Dec. 28, 2002
(86) PCT No.: PCT/AU02/01764

(30) Foreign Application Priority Data
Dec. 28, 2001 (AU) PR 9778
Jun. 5, 2002 (AU) PS 2797

(51) Int. Cl. G01F 23/00; G21G 1/06

(52) U.S. Cl. 250/360.1; 250/358.1; 376/159

(57) ABSTRACT

A bulk material analyser (10) and method of assembly for analysis of bulk material on a conveyor belt (11) passing through the analyser (10) between a radiation source (12) and a radiation detector (13). The analyser (10) includes a generally C-shaped housing (14) extending around an open-sided aperture (15) for passage of the belt (11). The housing (14) is substantially filled with radiation shielding material (17) to provide radiation shielding around the aperture (15). A removable block (18) of radiation shielding material closes the open side of the aperture (15) and provides surrounding radiation shielding of the aperture.

### FIELD OF THE INVENTION

This invention relates to bulk material analysers. In particular the invention relates to bulk material analysers in which bulk material is analysed on a conveyor belt passing through the analyser between a radiation source and a radiation detector.

### BACKGROUND ART

Bulk material analysers provide a way of determining the elemental content of material. Analysers of the type to which this invention relates are used to provide a measurement of the element or content of material on a moving conveyor belt. This can allow an on-line real time analysis of material. One widely used technique for bulk material analysis is known as prompt gamma neutron activation analysis (PGNAA). This technique involves the irradiation of the material to be analysed with neutrons from an appropriate source. The absorption of neutrons by the material results in the emission of gamma rays. The gamma ray emission spectrum is characteristic of the elements in the bulk material. Thus an appropriate detector can be used to measure the emitted gamma ray spectrum and a suitable analysis performed to provide an indication of the elemental content of the material. The use of radioactive neutron sources requires suitable shielding of the analyser and in particular the region in which radiation and neutrons are transmitted. Prior art analysers such as that described in Australian Patent No. 676056 use blocks of shielding material that are arranged around the active region and the conveyor belt to provide the necessary radiation shielding. One of the requirements of the construction of the analyser, and in particular the radiation shielding, is the ability to position the analyser around an existing conveyor belt without the need to physically break the belt to pass it through the analyser.

### DISCLOSURE OF THE INVENTION

It is an object of this invention to provide a bulk material analyser for analysis of bulk materials on a conveyor belt passing through the analyser between a radiation source and a radiation detector that will at least provide a useful alternative to existing analysers. It is also an object of this invention to provide a method of assembly of such an analyser.

According to one aspect of this invention there is provided a bulk material analyser for analysis of bulk material on a conveyor belt passing through the analyser between a radiation source and a radiation detector, said analyser including a generally C-shaped housing extending around an open-sided aperture for passage of said belt, said housing being substantially filled with radiation shielding material to provide radiation shielding around said aperture, and a removable block of radiation shielding material to close the open side of said aperture and provide surrounding radiation shielding of said aperture.

Preferably, a moderator insert is fitted into said aperture to at least partially define a conveyor passageway. In a preferred form of the invention the removable block of shielding material includes an inner portion of moderator material that also partially defines the conveyor passageway.

In one preferred form of the invention the radiation source is disposed within the moderator insert. In this form of the invention the radiation detector is located in the radiation shielding on the side of the aperture remote from the source.

Preferably, the moderator insert and removable block of shielding material combine to form a flat bottomed V-shaped passageway for the conveyor belt.

In the preferred form of the invention the moderator insert is surrounded by radiation shielding material on all sides. That is, radiation shielding is also provided at the ends of the moderator material in the longitudinal or travelling direction of the conveyor belt.

The preferred shielding material is CNS (cast neutron shielding). The CNS is preferably poured into the housing in liquid form and allowed to set.

According to a second aspect of this invention there is provided a method of assembly of a bulk material analyser for analysis of bulk material on a conveyor belt passing through the analyser between a radiation source and a radiation detector, said method including the steps of forming a generally C-shaped housing around an open-sided aperture for passage of said conveyor belt, and substantially filling said housing with fluid radiation shielding material to provide a radiation shielding around said aperture.

The radiation shielding is preferably CNS. The CNS is preferably poured into the housing as a liquid in a sequence of steps. According to the preferred embodiment a first portion of the base of the housing is filled with CNS. Subsequently the moderator insert is positioned and a second pouring of CNS takes place. In a further step the radiation detector assemblies are fitted to the upper portion of the housing and a further pour of CNS is made to substantially fill the housing.

It will be apparent that the analyser of the present invention has a configuration which allows the analyser to be positioned about an existing conveyor belt without breaking off the belt. The removable block of radiation shielding material provides a convenient and efficient way for the belt to be introduced into the conveyor passageway that is formed by the moderator insert and removable block in the preferred embodiment of the invention. Additionally, the assembly of the analyser of the preferred embodiment by sequential pourings of liquid CNS is relatively simple and efficient.

One embodiment of the invention will now be described, by way of example only, with reference to the accompanying drawings.

### BRIEF DESCRIPTION OF THE DRAWINGS

FIG. 1 is a schematic transverse sectional view through the centre of a bulk material analyser according to this invention;

FIG. 2 is a schematic transverse view similar to FIG. 1 taken towards one end of the bulk material analyser of this invention;

FIG. 3 is a schematic longitudinal sectional view of the bulk material analyser of FIGS. 1 and 2; and

FIG. 4 is a schematic isometric view of the bulk material analyser shown in FIGS. 1 to 3 positioned about a conveyor belt.

### BEST MODE FOR CARRYING OUT THE INVENTION

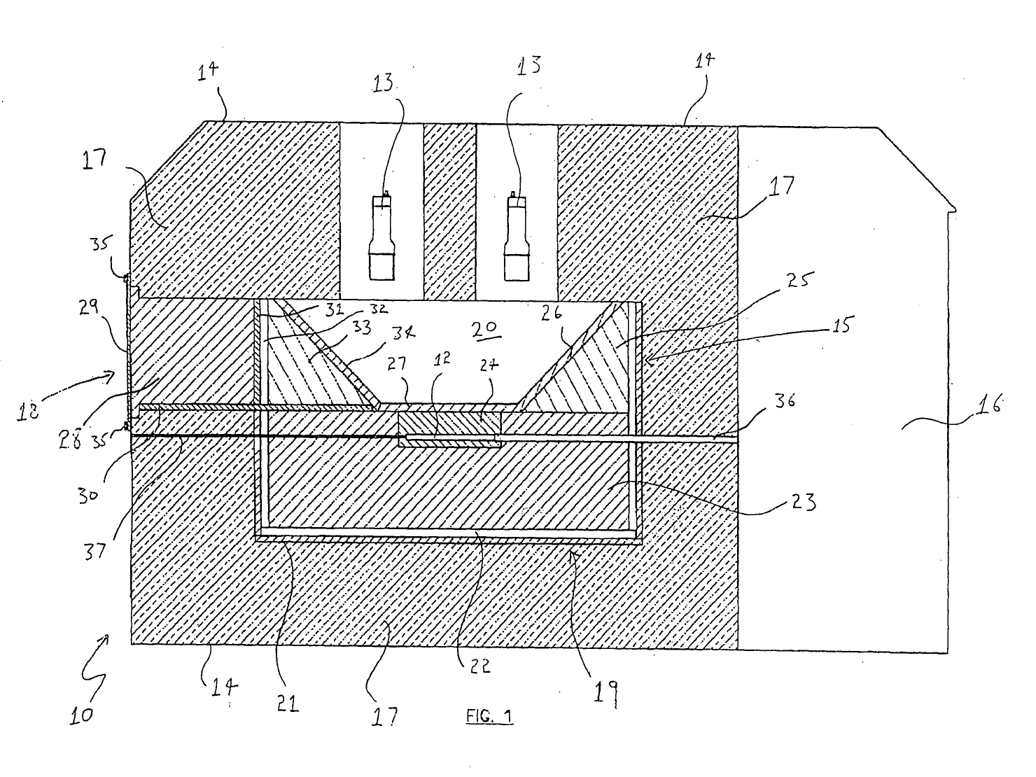

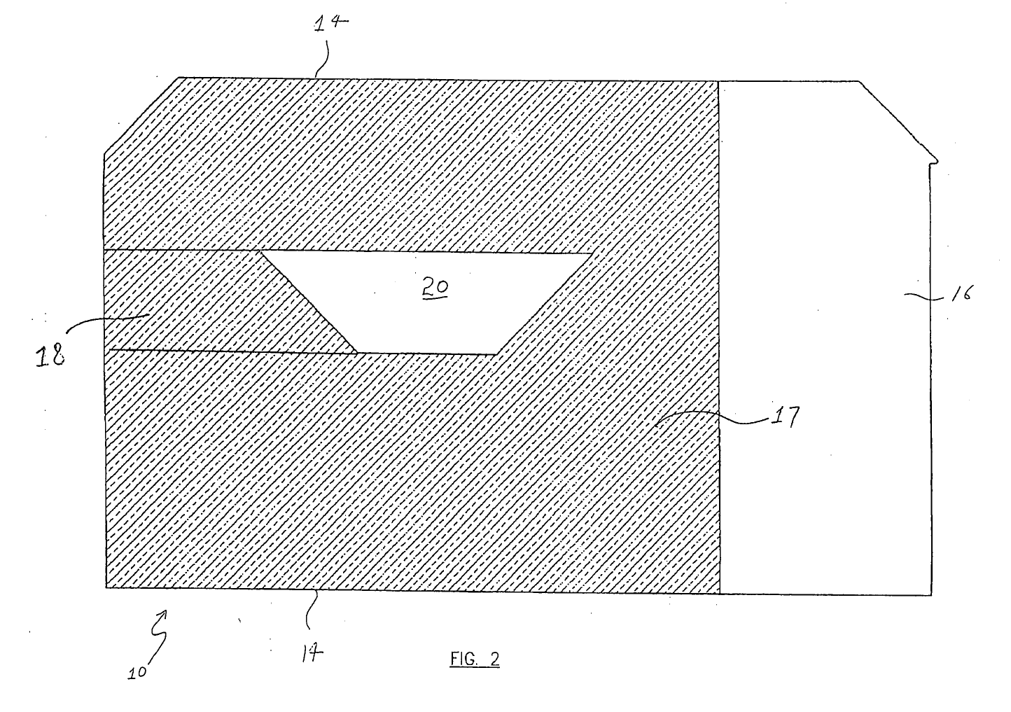

Referring to FIGS. 1 to 4 the bulk material analyser 10 of this invention provides for the analysis of bulk material (not shown) on a conveyor belt 11 that passes through the analyser 10. The conveyor belt 11 transports the bulk material between a radiation source 12 and radiation detectors 13. As will be appreciated by those skilled in the art any suitable source and detector combination can be used. The source and detector configuration do not form part of this invention and will not be described in detail.

The analyser is formed by a C-shaped housing 14 (best seen in FIGS. 1, 2 and 4) which extends around a rectangular aperture 15. Provision is made for the inclusion of an electronics cabinet 16 on one side of the housing 14. The electronics cabinet includes conventional control and analysis systems for the analyser do not form part of the invention and will not be described in detail.

The housing 14 is substantially filled with radiation shielding material shown at 17. In the preferred form of the invention the shielding material is CNS that has been poured into the housing in liquid form as described below. The CNS filled housing 14 thus provides shielding that extends around the rectangular aperture 15. A removable block 18 including a further CNS insulation. used to close an open side of the aperture 15 and complete the surrounding of the aperture 15 with radiation shielding material.

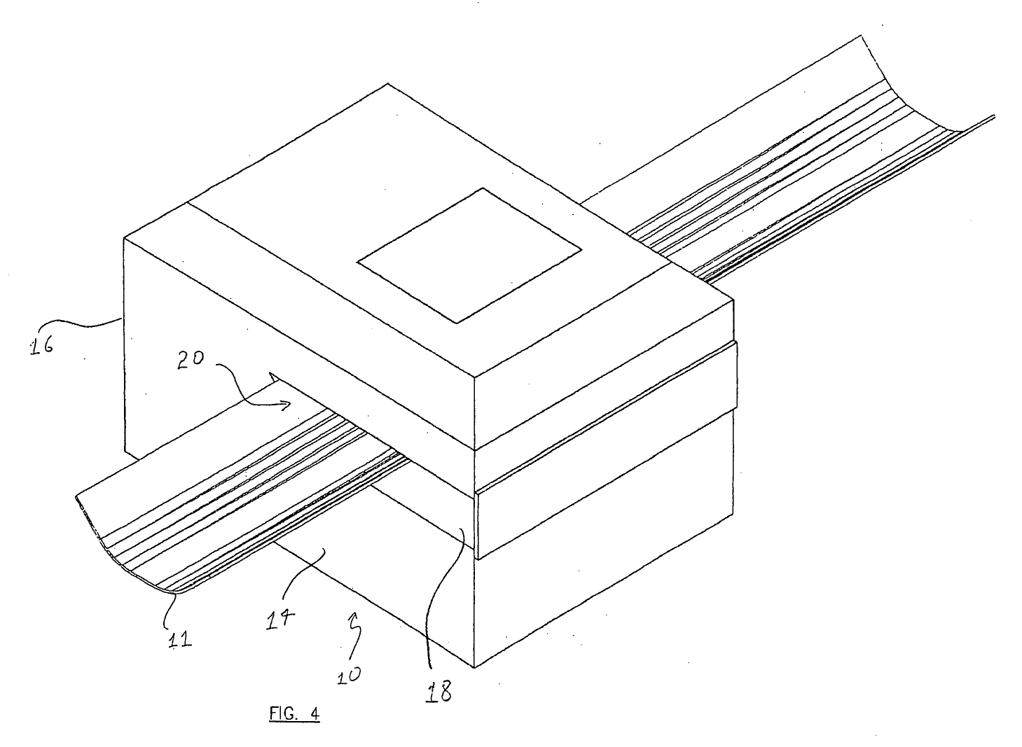

A moderator insert 19 is fitted to the aperture 15 to define a conveyor passageway 20. The conveyor passageway is of flat bottomed V-shaped cross section. Moderator insert 19 is formed in a rectangular plywood box 21. The box 21 has a thin lining of high density polyethylene (HDPE) 22. The lower part of the moderator insert is formed by a graphite block 23 which acts as a secondary neutron moderator. A second block 24 of higher density bismuth moderator material is provided to house the radiation source 12 and acts as a primary moderator. A further block of secondary moderator material 25 having a triangular cross section is provided in the moderator insert to support an upwardly inclined wall of the conveyor passageway 20 defined by a thin layer of graphite 26. The flat bottom of the V-shaped passageway is formed by a similar thin layer of graphite 27. As shown in FIG. 1 removable block 18 is made up of a number of components. A first portion of CNS shielding 28 is provided adjacent a metal cover plate 29. The lower edge of block 18 is defined by a plywood form board 30. This form board 30 supports the CNS shielding 28 and sequentially a further plywood layer 31 a thin layer of HDPE 32 and another triangular block of secondary moderator 33. The triangular block of secondary moderator 33 in turn supports a thin layer of graphite 34 that defines the other of upwardly inclined sides of the V-shaped conveyor passageway 20. The assembly between cover plate 29 and graphite layer 34 including form board 30 can be removed from the analyser 10 to allow positioning of the analyser 10 about a conveyor belt 11 as shown in FIG. 4. In operation the removable block assembly 18 is retained in place by bolts 35 extending through cover plate 29.

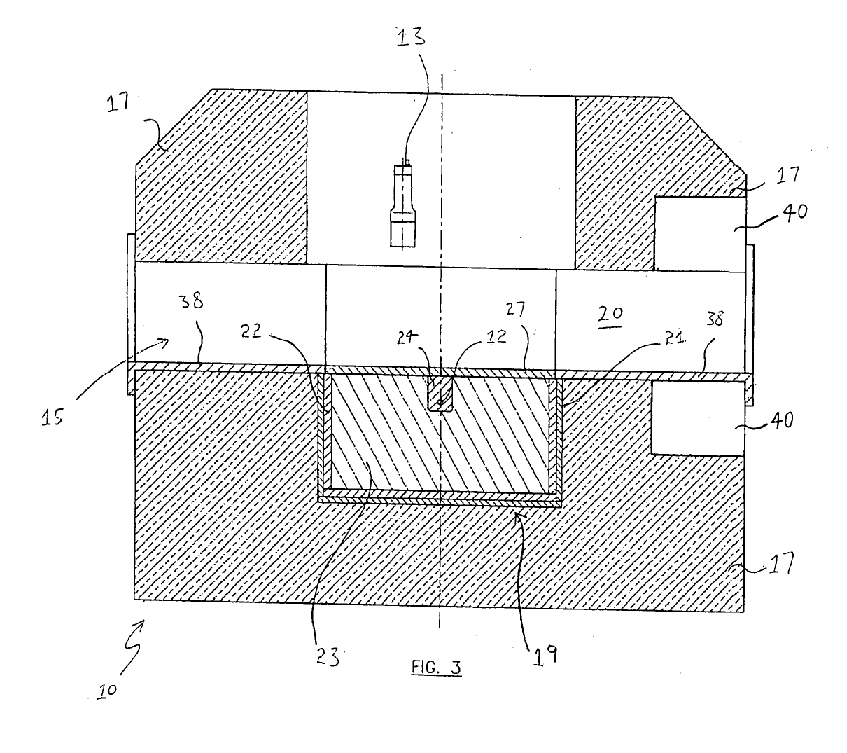

As best seen in FIG. 3 the moderator insert 19 is surrounded on all sides by the CNS shielding. That is the insert 19 has shielding both on the lateral and longitudinal sides. The conveyor passageway 20 through the CNS shielding either side of moderator insert 19 has the bottom and upwardly angled sides lined with this layers of HDPE 38 instead of the graphite used in the moderator insert 19.

A tube 36 is provided to facilitate placement of source 12 in secondary moderator 24. A second tube 37 extends from the other side of the analyser to provide for insertion of a rod to expel the source 12 when required.

Voids, indicated by dashed lines 40, may also be formed above and below the conveyor passageway 20. These voids 40 allow a microwave antenna horn assembly to be fitted if required for other measurements such as moisture content. In accordance with the method of this invention the analyser is formed by pouring of liquidified CNS into the housing 14. The CNS preferably has the following composition:
60% Polyethylene Beads by weight
20% Borax by weight
20% Polyester Resin by weight

In the preferred method of assembly the CNS is poured in a number of stages. A first pouring of the CNS forms a base up to the desired position of the bottom of moderator insert 19. The moderator insert is then positioned and a second pouring of the CNS takes place to fill around the moderator insert. In one form of the invention formwork (not shown) is positioned to define the upper side of aperture 20 before a final pouring of the CNS radiation shielding. Appropriate cavities for detectors 13 and voids 40 for the microwave antenna horn assembly can also be defined by formwork or parts of the housing 14.

The remainder of the assembly process is substantially conventional and will be known to those skilled in the art of assembly of bulk material analysers.

The foregoing describes only one embodiment of the present invention and modifications can be made without departing from the scope of this invention.

The reference to any prior art in this specification is not, and should not be taken as, an acknowledgement or any form of suggestion that that prior art forms part of the common general knowledge in Australia.

1. A bulk material analysis for analysis of bulk material on a conveyor belt passing through the analyser between a radiation source and a radiation detector, said analyser including a generally C-shaped housing extending around an open-sided aperture for passage of said belt, said housing being substantially filled with radiation shielding material to provide radiation shielding around said aperture, and a removable block of radiation shielding material to close the open side of said aperture and provide surrounding radiation shielding of said aperture.

2. A bulk material analyser as claimed in claim 1 wherein a moderator insert is fitted into said aperture to at least partially define a conveyor passageway.

3. A bulk material analyser as claimed in claim 2 wherein said removable block of shielding material includes an inner portion of moderator material that also partially defines the conveyor passageway.

4. A bulk material analyser as claimed in claim 2 wherein a radiation source is disposed within the moderator insert.

5. A bulk material analyser as claimed in claim 4 wherein a radiation detector is located in the shielding on the side of the aperture remote from said source.

6. A bulk material analyser as claimed in claim 2 wherein said moderator insert and removable block of shielding material combine to form a flat bottomed V-shaped passageway for the conveyor belt.

7. A bulk material analyser as claimed in claim 2 wherein said moderator insert is surrounded by radiation shielding material on all sides.

8. A bulk material analyser as claimed in claim 6 wherein said moderator insert includes a rectangular block of secondary neutron moderator positioned below said V-shaped passageway.

9. A bulk material analyser as claimed in claim 8 wherein said block of secondary neutron moderator includes an insert of primary neutron moderator.

10. A bulk material analyzer as claimed in claim 8 wherein said moderator insert includes a triangular block of secondary neutron moderator defining one side of said V-shaped passageway.

11. A bulk material analyser as claimed in claim 10 wherein inner portion of moderator material of said removeable block is a triangular block of secondary neutron moderator.

12. A bulk material analyser as claimed claim 1 wherein said shielding material is cast neutron shielding.

13. A bulk material analyser as claimed in claim 12 wherein the cast neutron shielding is substantially 60% Polyethylene Beads by weight, 20% Borax by weight and 20% Polyester Resin by weight.

14. A method of assembly of a bulk material analyser for analysis of bulk material on a conveyor belt passing through the analyser between a radiation source and a radiation detector, said method including the steps of forming a generally C-shaped housing around an open-sided aperture for passage of said conveyor belt, and substantially filling said housing with fluid radiation shielding material to provide a radiation shielding around said aperture.

15. A method as claimed in claim 14 wherein the radiation shielding is cast neutron shielding poured into the housing as a liquid in a sequence of steps including (a) filling a first portion of the base of the housing with cast neutron shielding; (b) positioning a moderator insert and filling a second portion of the housing with cast neutron shielding; and (c) fitting the radiation detector assemblies to the upper portion of the housing and making a further pour of cast neutron shielding to substantially fill the housing.
